(19) United States
(12) Patent Application Publication
(10) Pub. No.: US 2020/0000659 A1
(43) Pub. Date: Jan. 2, 2020

(54) Stair Climbing Apparatus

(71) Applicant: Liset Limited, Christchurch (NZ)

(72) Inventors: Peter Brian LINSCOTT, Christchurch (NZ); Steven Hyunwook SEO, Christchurch (NZ)

(21) Appl. No.: 16/455,375

(22) Filed: Jun. 27, 2019

(30) Foreign Application Priority Data
Jun. 28, 2018 (NZ) 743943

(51) Int. Cl. A61G 5/06; B62D 55/075

(52) U.S. Cl. CPC A61G 5/061; B62D 55/075; A61G 5/04; A61G 5/068; A61G 5/066

(57) ABSTRACT

An improved vehicle is provided that has an excellent obstacle overcoming ability, including stair climbing. The apparatus comprises a frame, and a pair of endless track units positioned on opposite sides. Each track unit has a plurality of telescoping rollers in contact with the inner track surface configured to guide the track around a track pathway, and move vertically when navigating over obstacles. Each track unit further comprises a drive assembly in contact with the track, and movable between a raised position and a lowered position, such that movement of the drive assembly also operates to provide track tension.

### RELATED APPLICATION

This application claims priority from New Zealand Application No. 743943, filed on Jun. 28, 2018.

### FIELD OF THE INVENTION

The present invention relates to a stair climbing apparatus. More particularly, but not exclusively, it relates to a tracked stair climbing apparatus with track units and rollers.

### BACKGROUND OF THE INVENTION

In the natural world, the use of legs prevails, and thousands of years of use by both humans and animals have proven this to be a superb and versatile method of locomotion. As a means of navigating both smooth and rugged terrain, it is generally unsurpassed, and its only limitations are its mechanical complexity and the extreme intelligence and sensing capabilities required to make it work. Despite many centuries of attempts to mechanically emulate walking devices, these complexities have yet to be overcome.

In the man-made world, we have the wheel, rightfully acknowledged as one of the greatest of inventions, yet compared to the leg it is extremely limited in use. The wheel's main advantage is its inherent simplicity. However, the wheel's simplicity requires that the environment must be tailored to suit its many limitations, hence the creation at phenomenal expense of entire infrastructures such as road systems. Although wheel variations such as tracked vehicles have increased the versatility of ‘wheels’ and their ability to negotiate obstacles, they essentially remain limited to use in carefully controlled environments.

Advances in mobility device technology throughout the past several decades may have improved the function and quality of life of people with mobility impairments who rely on wheeled mobility. Mobility devices may also be used by people without mobility impairments, simply to improve ease of transportation between destinations. However, these mobility devices generally confine the user to moving on relatively flat, smooth surfaces. But the world of the mobility device user is anything but flat and smooth, both inside the home and outside in the community environment.

It may be desirable for a mobility device to neutralise both man-made and natural environments empowering users with greater independence and freedom. It may be desirable for a mobility device to be capable of both moving efficiently over smooth surfaces, while being able to navigate vertical obstacles and uneven surfaces.

Furthermore, it is desirable for these advances to be applied to unmanned ground vehicles (UGVs) which can be used for transporting articles, used in emergency services or organisations such as the military.

A mobility device which can be adapted to moving efficiently over smooth surfaces, while being able to navigate vertical obstacles and uneven surfaces may improve UGVs' ability to be more flexible, responsive, and/or agile. Unmanned systems may be used to reduce or eliminate the requirement of human input to perform labour intensive or dangerous tasks.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For the purpose of this specification, where method steps are described in sequence, the sequence does not necessarily mean that the steps are to be chronologically ordered in that sequence, unless there is no other logical manner of interpreting the sequence.

It is an object of the present invention to provide a stair climbing apparatus which overcomes or at least partially ameliorates some of the abovementioned disadvantages or which at least provides the public with a useful choice.

### BRIEF DESCRIPTION OF THE INVENTION

According to a first aspect the invention broadly comprises a stair climbing apparatus comprising:
a frame,
a pair of track units positioned on opposite sides of the frame, each track unit comprising:
   a track having an inner track surface and an outer track surface,
   a plurality of rollers in contact with the inner track surface configured to guide the track around a track pathway, and
   a drive assembly comprising a drive wheel in contact with the track, and
wherein the drive assemblies are movable between a raised position and a lowered position and provides track tension.

According to another aspect each drive assembly provides the primary means of track tension for each respective track.

According to another aspect each drive assembly provides the sole means of track tension for each respective track.

According to another aspect four of more of the rollers on each track unit are movable rollers vertically moveable relative to the frame.

According to another aspect two or more of the rollers on each track unit are fixed carrier rollers mounted in fixed positions on the frame.

According to another aspect the apparatus comprises two to eight fixed carrier rollers.

According to another aspect each drive assembly translates a stroke length proportional to a vertical distance travelled by the movable rollers.

According to another aspect each drive assembly translates a stroke length equal to half the sum of the vertical distances travelled by the movable rollers.

According to another aspect each drive assembly translates a distance between 100 mm and 900 mm to move between the raised position and the lowered position.

According to another aspect each drive assembly translates a distance between 200 mm and 700 mm to move between the raised position and the lowered position.

According to another aspect each drive assembly is positioned on or near the centreline of mass of each respective the track unit.

According to another aspect each track unit has a vertical line of symmetry.

According to another aspect each drive assembly is movable between the raised position and the lowered position to take up tension as the movable rollers move between an extended condition and a retracted condition relative to the frame.

According to another aspect the movable rollers on each track unit are located at the bottom end of vertically movable legs.

According to another aspect the vertically movable legs are telescoping legs.

According to another aspect the telescoping legs can extend and retract to negotiate vertical obstacles.

According to another aspect each track pathway and respective telescoping legs are in the same vertical plane.

According to another aspect each track pathway is in an inclined plane with respect to a vertical plane.

According to another aspect each drive wheel engages with the respective track to drive the track around each respective track unit.

According to another aspect the two drive assemblies can move independently from each other.

According to another aspect each drive assembly moves towards the lowered position to increase track tension.

According to another aspect each drive assembly provides a downward force on the track to provide track tension.

According to another aspect each drive assembly provides track tension passively as the weight of the drive assembly provides a downward force on the track.

According to another aspect each drive assembly comprises supplementary weight elements to provide an increased downward force on the track.

According to another aspect each drive wheel is located exterior to the track pathway of each respective track and provides a downward force on the track.

According to another aspect each drive wheel is located within the track pathway of each respective track and configured to provide a downward force on the track.

According to another aspect each drive assembly moves towards the raised position to increase track tension.

According to another aspect each drive wheel is located within the track pathway of each respective track configured to provide an upwards force on the track.

According to another aspect each track unit comprises an actuator to actively move each drive assembly to a raised position or lowered position.

According to another aspect each track forms an enclosed track pathway.

According to another aspect each track units comprise drive assembly guide rails.

According to another aspect the front two adjacent movable rollers are grouped together to simulate a front foot, and the rear two adjacent movable rollers are grouped together to simulate a rear foot on each respective track unit.

According to another aspect the apparatus comprises a lower door to unload an article below the apparatus.

According to another aspect the apparatus comprises an actuator to load the parcel through the lower door autonomously.

According to another aspect the frame comprises a support platform sized and configured to support a seat.

According to another aspect the frame comprises a support platform sized and configured to support articles for delivery.

According to another aspect the track is a continuous flexible track.

According to another aspect the track comprises high friction rubber.

Other aspects of the invention may become apparent from the following description which is given by way of example only and with reference to the accompanying drawings.

As used herein the term “and/or” means “and” or “or”, or both. As used herein “(s)” following a noun means the plural and/or singular forms of the noun.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 shows a perspective view of a stair climbing apparatus.

FIG. 2 shows a side view of a stair climbing apparatus.

FIG. 3A-C shows schematics of different drive assembly configurations.

FIG. 4A shows a back view of a track aligned with telescoping legs.

FIG. 4B shows a side view of a track aligned with telescoping legs.

FIG. 5A shows a back view of an inclined track.

FIG. 5B shows a side view of an inclined track.

FIG. 6 shows a side view of a stair climbing apparatus in a standing position.

FIG. 7A shows a side view of a stair climbing apparatus inclined along a longitudinal axis.

FIG. 7B shows a side view of a stair climbing apparatus inclined along a lateral axis.

FIG. 8A-D shows a stair climbing procedure of the stair climbing apparatus.

FIG. 9A shows a stair climbing apparatus with a short body length.

FIG. 9B shows a stair climbing apparatus with a long body length.

FIG. 10A shows a side view of a stair climbing apparatus with retracted legs.

FIG. 10B shows a side view of a stair climbing apparatus with extended legs.

FIG. 11 shows a perspective view of a stair climbing apparatus with a lower door.

### DETAILED DESCRIPTION OF PREFERRED EMBODIMENTS

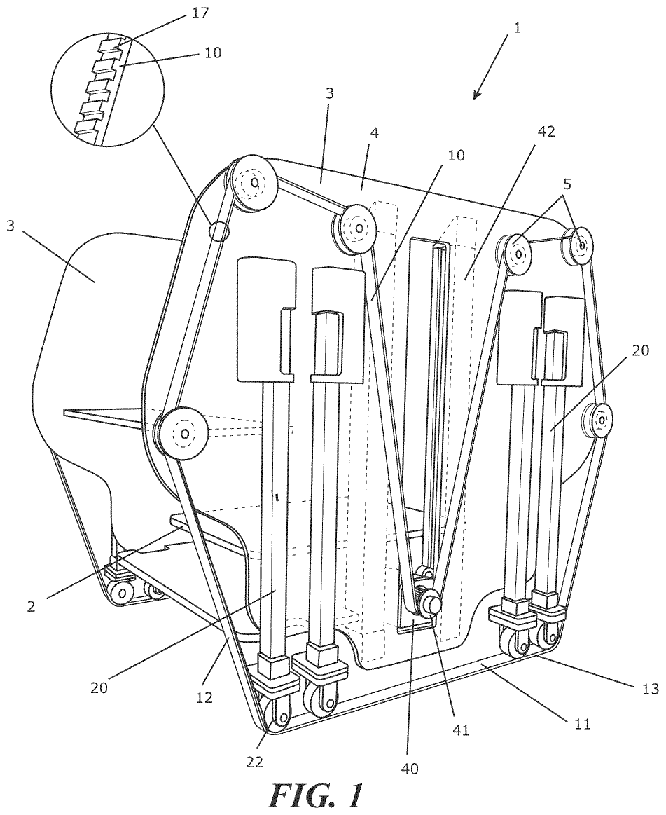

According to various aspects of the various embodiments of the present invention as illustrated in FIGS. 1-11, there is provided a stair climbing apparatus 1 which will now be described. It will be appreciated that these figures are schematic views that illustrate the general principles of construction, and that the invention is not limited to the precise mechanical configuration illustrated.

As shown in FIG. 1, the stair climbing apparatus 1 comprises a frame 4, and a pair of track units 3 positioned on opposite sides of the frame.

In some configurations, the frame 4 comprises a support platform 2.

Preferably, the two track units 3 can move independently from each other. Preferably, movement on one side of the stair climbing apparatus 1 is not dependent on the other.

Preferably, each track unit 3 is substantially symmetrical to improve stability and balance of the track units. In the preferred configurations, the track units 3 have a vertical line of symmetry.

The pair of track units 3 are preferably structured identically, to mirror each other, so each side of the stair climbing apparatus 1 can operate harmoniously.

Preferably, the track 10 comprises an inner track surface 11 and an outer track surface 12.

Preferably, each track unit 3 comprises a track 10 and a plurality of rollers 5, 22. Preferably, the plurality of rollers 5, 22 are configured to guide the track 10 around a track pathway.

Preferably, each track unit 3 comprises a frame 4, and part of the track 10 is supported on the frame.

A plurality of carrier rollers 5 are preferably mounted in fixed positions on the frame 4. Preferably the carrier rollers 5 guide the track 10. Preferably, the carrier rollers 5 have a smooth surface. Preferably, the apparatus 1 comprises two or more fixed carrier rollers 5 mounted in fixed positions on the frame 4.

Preferably, the apparatus 1 comprises two or more rollers on each track unit 3 which are movable rollers 22 vertically movable relative to the frame 4.

In the preferred configuration, the apparatus 1 comprises four or more rollers on each track unit 3 which are movable rollers 22 vertically movable relative to the frame 4.

In some configurations, each track unit 3 comprises a track 10 and vertically movable legs 20. Preferably, movable rollers 22 on each track unit 3 are located at the bottom end of the vertically movable legs 20.

In the preferred configuration, the vertically movable legs 20 are telescoping legs. Preferably, the telescoping legs 20 extend and retract to negotiate vertical obstacles.

Preferably, the movable rollers 22 press against the inner track surface 11, in a lower ground contacting area. As the movable rollers 22 press against the inner track surface 11, the lower track profile 13 dynamically changes so the stair climbing apparatus 1 can negotiate different surfaces or obstacles.

Preferably, the movable rollers 22 move vertically between an extended condition and a retracted condition relative to the frame.

In some configurations, each track unit 3 comprises two or more telescoping legs 20.

In the preferred configurations, each track unit 3 comprises four or more telescoping legs 20.

In the preferred configuration, each track unit 3 comprises four telescoping legs 20.

Preferably, each track unit 3 comprises a drive assembly 40. The drive assembly 40 is configured to drive the track 10 so the stair climbing apparatus 1 can move forwards or backwards.

The drive assembly 40 is preferably configured to drive the track 10 around the track unit 3 to adjust the position of the track to reduce slack and provide tension.

Preferably, the drive assembly 40 comprises a drive wheel 41. The drive wheel 41 is preferably in contact with the track 10. Preferably, the drive wheel 41 engages with the respective track 10 to drive the track around each respective track unit 3.

Preferably, the two drive assemblies 40 can move independently from each other.

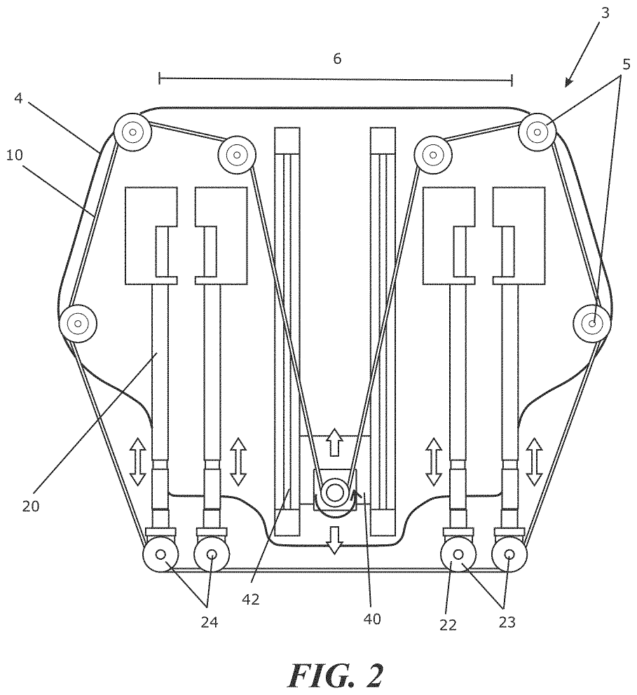

In the preferred configurations, each drive assembly 40 is movable between a raised position and a lowered position and provides track tension as shown by the arrows in FIG. 2. The drive assembly 40 may need to take up track tension as the track length 16 around the movable rollers 22 changes as they move between a retracted and extended condition.

The stair climbing apparatus 1 can intelligently negotiate obstacles. For example, the stair climbing apparatus may climb stairs, travel on inclined or uneven surfaces comfortably, or elevate to different heights (e.g. to a standing position).

Traditionally wheeled or tracked vehicles are generally only efficient if the surface over which they travel is flat and relatively smooth. These vehicles usually fail if there are vertical obstacles, such as stairs, curbs or uneven terrain.

The stair climbing apparatus 1 may neutralise barriers in both man-made and natural environments. The stair climbing apparatus 1 can allow ground vehicles to negotiate many different types of terrain in a simple, practical, and cost-effective manner. The stair climbing apparatus 1 includes leg features and track features to create a surprisingly efficient mobility apparatus.

Traditional wheeled vehicles usually require regular surfaces in order to move. However, many surfaces are inaccessible to traditional wheeled vehicles due to large obstacles or surface unevenness.

In contrast to previous attempts to increase mobility, such as forming mechanical legs using a relatively literal mechanical copy of human linkages and a ‘stepping motion’, the stair climbing apparatus 1 simplifies forwards and backwards movement and up and down movement by using a track component 10 and telescoping legs 20.

Traditionally, legged vehicles exhibit low speeds, are difficult to build and need complex control algorithms. The present stair climbing apparatus 1 aims to at least partially ameliorate these limitations. The stair climbing apparatus 1 provides a simpler and more efficient alternative.

Additionally, the stair climbing apparatus 1 may be able to eliminate some limitations of conventional tracked mobility vehicles. Many conventional tracked mobility vehicles cannot navigate high obstacles such as curbs or stairs.

Even conventional stair climbing tracked vehicles may be hazardous. When a conventional stair climbing tracked vehicle navigating steps, the track performs the stair climbing motion while supporting its own weight. Often the track grip the edges of stairs or obstacles using ridges on the belt. There is a danger of sliding down stairs, especially if they are wet.

In comparison, the present stair climbing apparatus 1 is supported on the horizontal surface of the stairs and not the edges. The danger of sliding down stairs can be greatly reduced as the stair climbing apparatus 1 is supported on horizontal surfaces.

It is anticipated that the stair climbing apparatus 1 can be used to move people or articles from one place to another. People or articles may be transported even over uneven terrain or over vertical obstacles such as curbs or stairs.

The stair climbing apparatus 1 can be used as part of an unmanned vehicle for emergency purposes, robotics industry, the military, or other commercial applications.

The stair climbing apparatus 1 may also be used to improve mobility of people. In particular, the stair climbing apparatus 1 can be used to improve mobility and quality of life for disabled individuals, or individuals with limited mobility.

It is anticipated that the stair climbing apparatus 1 can be adapted for different applications. For example, the frame comprises a support platform 2 sized and configured for different purposes. The space between track units 3 can be adjusted depending on the apparatus' intended use.

In the preferred configuration, the track units 3 are spaced apart to provide a large carrier space. The large carrier space can be used to support a multitude of specialised instruments such as used for emergency services.

In other configurations, the track units 3 are spaced apart to provide a small carrier space. This may be advantageous if it is desirable to navigate narrow passageways.

In one configuration, the frame comprises a support platform 2 sized and configured to support a seat for a person.

In another configuration, the frame comprises a support platform 2 sized and configured to support articles for delivery.

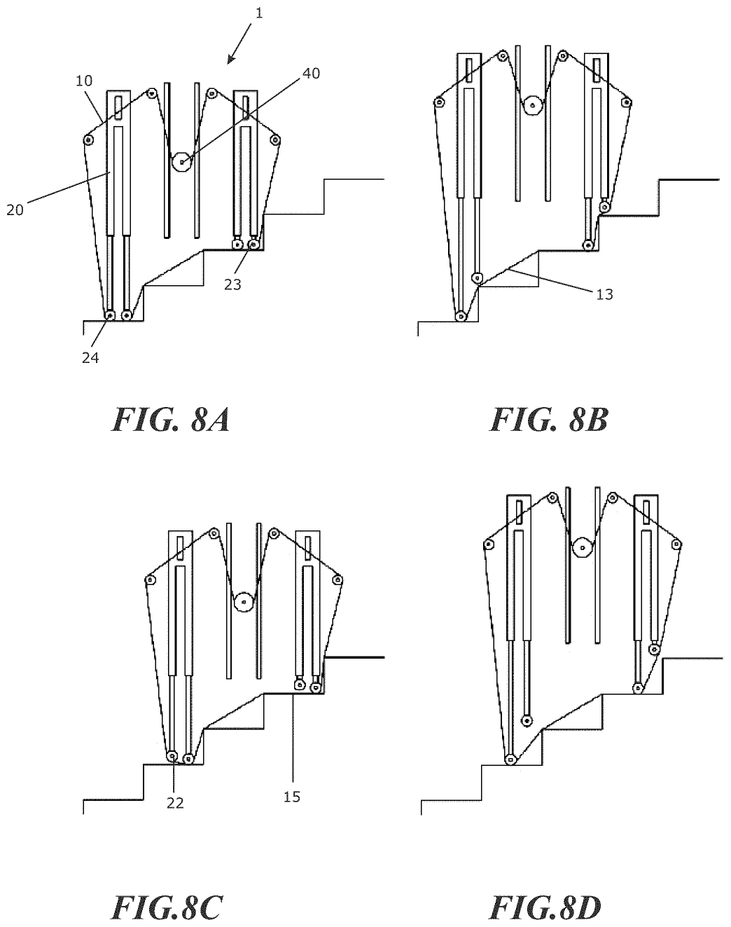

The stair climbing apparatus 1 preferably comprises a track 10. Preferably, the track 10 provides a contact surface 15 with the ground as shown in FIG. 7A and 8C.

Preferably, the lower track profile 13 dynamically changes from the whole lower track profile contacting the ground as illustrated FIG. 1 when the apparatus 1 is on a flat surface, to a portion of the lower track profile contacting the ground as illustrated in FIG. 8 such as when the apparatus is on uneven surfaces or navigating obstacles.

In the preferred configurations, the track 10 is an enclosed track where the stair climbing apparatus 1 is propelled forwards or backwards as the track is driven around the track unit 3. An enclosed track can be defined as a track which forms an unbroken looped track profile.

A stair climbing apparatus 1 comprising tracks 10 may be advantageous as it can move faster on a flat surface in comparison to legged vehicles. Traditionally vehicles comprising legs exhibit low speeds, are difficult to build and may need complex control algorithms to control the legs. A flat surface is defined as a surface which is substantially level without raised regions or indentations which doesn't require the telescoping legs 20 to retract or expand to navigate.

Unlike vehicles comprising multiple legs, the present stair climbing apparatus 1 is able to propel forwards and backwards as the drive assembly 40 moves the track 10 around the track unit 3. In comparison, legged vehicles often comprise heavy mechanisms, as they need a large number of actuators to move multiple legs and joints associated with the legs, requiring large energy consumption even when navigating flat surfaces.

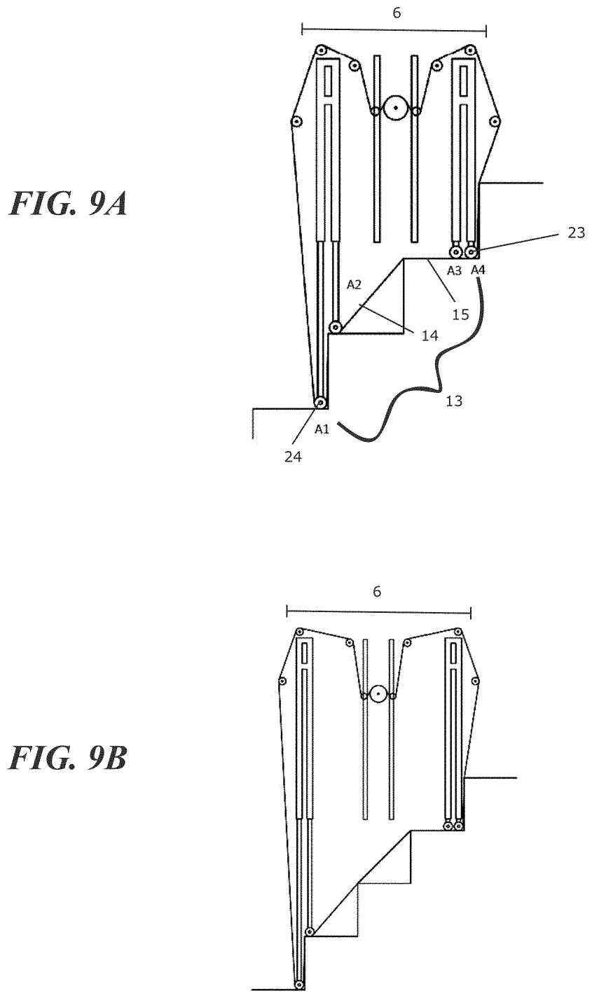

The stair climbing apparatus 1 comprising tracks 10 may also be advantageous when navigating vertical obstacles or uneven surfaces as illustrated in FIG. 9A. As one or more movable rollers 22 retract upwards, a region of the lower track profile 13 conforms to the rollers 22 and also moves upwards to form a lifted track region 14 thereby navigating vertical obstacles, or uneven surfaces which cannot be simply driven over by the tracks. The lifted track region 14 as shown in FIG. 9A is not in contact with the ground surface or the obstacle.

As the stair climbing apparatus 1 navigate a vertical obstacle such as stairs, tracks 10 may be advantageous, as the track can also form a surface contact region 15. A tracked climbing apparatus 1 forming a surface contact region 15 may be beneficial as the apparatus is more stable as the apparatus is supported on the horizontal surface of the vertical obstacle. Traditionally tracked vehicles may be prone to slipping as many are solely supported by the edges of the stairs, instead of a horizontal surface on the step as shown with the present stair climbing apparatus 1. Additionally, the track 10 of the present stair climbing apparatus 1 may not deteriorate as quickly as traditional tracked stair climbing apparatuses which travel along edges of steps, as the stair climbing apparatus 1 is preferably supported on the horizontal surfaces of steps.

In the preferred configurations, the track 10 is flexible so it can conform to different lower track profiles 13 as the movable rollers 22 retract and extend. A flexible track 10 may be advantageous as it provides a track which is relatively light. Furthermore, a flexible track 10 may be easier to maintain in comparison to tracks with discrete elements for example, as debris may get caught between discrete elements. A flexible track 10 may provide higher friction in comparison to a track with discrete elements.

Preferably, the track 10 is formed from a material which has a high tensile modulus. Preferably, the track 10 can resist elastic deformation well, as one or more extended telescoping legs 20 apply a force to the track 10 as it navigates different terrain or obstacles. Preferably the track 10 can resist elongation due to track material stretching which creates unwanted track slack. A track 10 which can resist deformation can minimise track slack, and minimise required work done by the drive assembly 40 to provide track tension.

In the preferred configuration, the track 10 comprises rubber.

It is anticipated that other materials can be used for the track 10 with similar physical properties such as the strength and flexibility of rubber such as polyurethane.

In the preferred configuration, the track 10 comprises a high-friction material such as high-friction rubber. A material with high-friction properties may be beneficial so it can grip the ground surface efficiently to propel the stair climbing apparatus 1 forwards or backwards along the ground surface.

In one configuration, the track 10 is a smooth tread.

In another configuration, the track 10 comprises a plurality of protrusions 17 on the outer surface 12 of the track 10 as shown in FIG. 1. In some configurations, the protrusions 17 are a series of soft elastomer cleats (or grousers) 17 located transversely on the outer surface 12 of the track 10 in FIG. 1. Cleats 17 can increase traction of continuous tracks 10 especially loose material such as soil or snow.

In some configurations, the track protrusions 17 can provide improved grip between the drive wheel 41 and the track 10.

In other configurations, the track 10 comprises a multitude of discrete elements to form a continuous track (not shown). Preferably, these discrete elements are rigid. In other configurations, the discrete elements may be semi-flexible.

In some configurations, the track 10 comprises a track belt with a protruding teeth profiles. This may be preferable to produce a high torque where a high carrying capacity is required. Preferably, a chain on a continuous belt and a sprocket-drive wheel is used. It is anticipated that small modifications to the carrier rollers 5 and the leg rollers 22 may need to be made to work in conjunction with a track belt with protruding teeth profiles.

In the preferred configurations, the track 10 is resistant to abrasion.

A durable track 10 is preferable as the stair climbing apparatus 1 may navigate many different terrains. Preferably, the track 10 is a durable to increase the lifetime of the track before it needs to be repaired or replaced.

Preferably, the track 10 has a width between 5 mm and 120 mm.

In the preferred configurations the track 10 has a width between 15 mm and 80 mm.

In one configuration, the track 10 has a width of about 20 mm.

A narrower track may be used for small unmanned ground vehicles for example. A wider track may be used for an apparatus designed off-road use.

Preferably, in some configurations the track 10 width relatively narrow to reduce the drag, and thus torque and power consumption required to increase the battery life and efficiency of the stair climbing apparatus 1.

Preferably, the track 10 is wide enough provide adequate a contact surface with the ground to ensure the stair climbing apparatus 1 remains stable. This may be balanced with the desire to keep the track 10 relatively narrow for aesthetic appeal. Preferably, the width and length of the track 10 is configured to reduce material cost and weight.

Preferably, the track 10 is guided to take a desired track pathway around the track units 3 by guiding elements 5. In the preferred configuration, the guiding elements 5 are carrier rollers.

In the preferred configurations, a plurality of fixed carrier rollers 5 guide the track 10. Preferably, the carrier rollers 5 is able to guide the track 10 smoothly as it moves around the track units 3.

Preferably, the carrier rollers 5 and the movable rollers 22 guide the track around a track pathway.

It is anticipated a range of different numbers and positions of carrier rollers 5 can be used to guide the track 10. The positions of the carrier rollers 5 can determine the length of continuous track 10 required for the apparatus 1.

Preferably, the track 10 is between 1000 mm and 6500 mm long.

In the preferred configurations, the track 10 is 1500 mm and 5000 mm long.

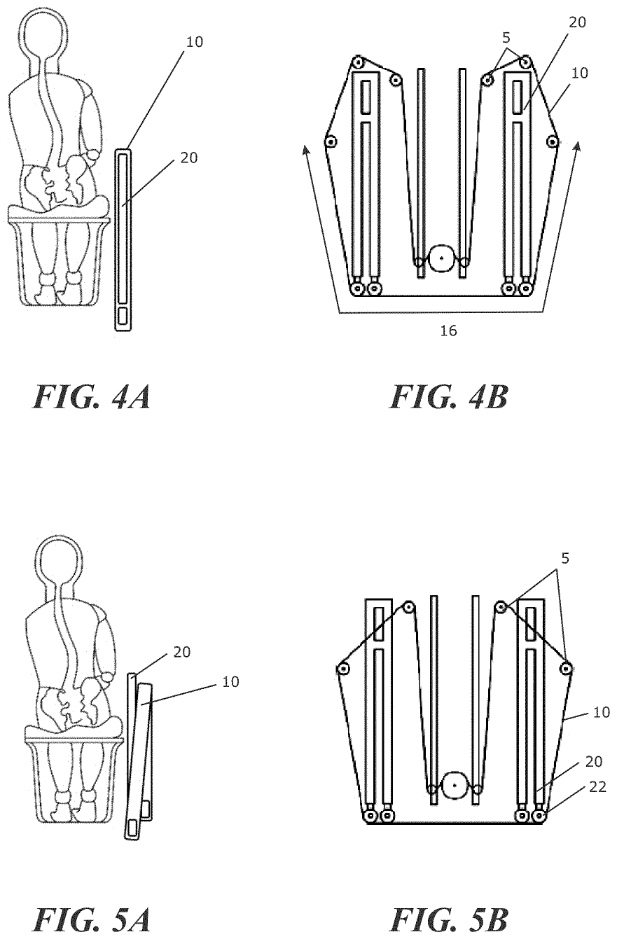

In some configurations, the track 10 is located around the entire telescoping legs 20 as shown in FIGS. 4A and 4B.

Preferably, each track pathway 10 and respective telescoping legs 20 are in the same vertical plane, as shown in FIG. 4A.

In some configurations, the vertical plane which the track 10 is on or parallel to the vertical plane of the telescoping legs 20.

In other configurations, the track 10 does not surround the entire length of the telescoping legs. In this configuration, the track 10 is inclined and does not lie on the vertical plane of the telescoping legs 20 as shown in FIGS. 5A and 5B. Preferably, the track pathway is in an inclined plane with respect to a vertical plane. This may be advantageous as this decreases the length of the track 10 required.

In some configurations, the drive assembly 40 is also shifted out of plane from the telescoping legs 20 to drive the inclined track 10.

Preferably, the stair climbing apparatus 1 comprises two to eight fixed carrier rollers 5 to guide the track 10.

In one configuration, as show in FIG. 4B, six carrier rollers 5 can be used to guide the track 10.

In another configuration, as shown in FIG. 5B, four carrier rollers 5 can be used to guide the track. In this configuration, a shorter track 10 length can be used.

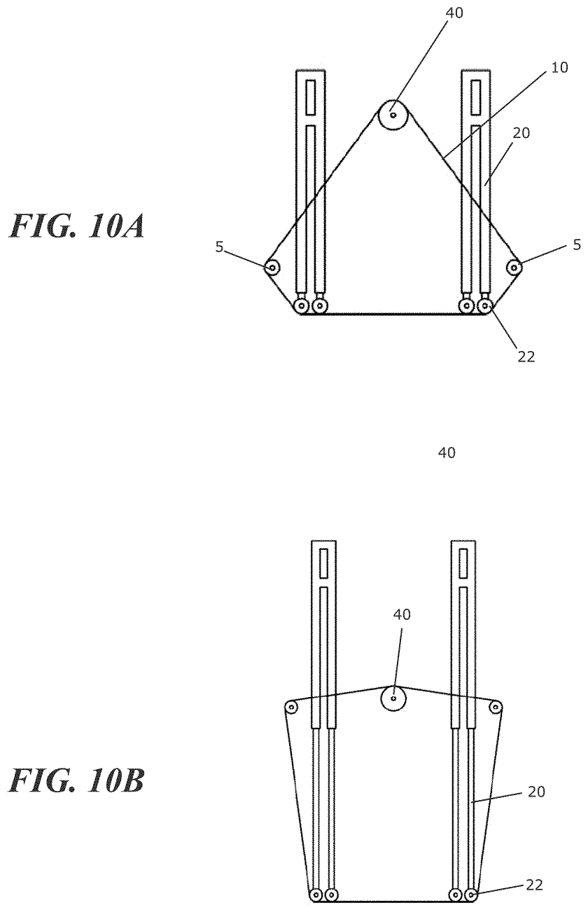

In yet another configuration, as shown in FIG. 10A, two carrier rollers 5 can be used to guide the track. In this configuration, an even shorter track 10 length can be used.

Preferably, the central carrier roller or rollers 5 set the stroke length of the drive assembly 40.

Preferably, the locations of the carrier rollers 5 guide the track 10 and provide the desired track path.

Preferably, the two side carrier rollers 5 prevent the track 10 and telescoping legs 20 from overlapping.

It is anticipated other guiding elements 5 known in the art can be used to guide the track 10 around the track units 3. For example, smooth protruding rods fixed or integrated with the frame can be used to guide the tracks 10.

The drive assembly 40 is configured to move the track 10 around the track unit 3 so the stair climbing apparatus 1 can move forwards or backwards. The track 10 may also be driven around the track unit 3 to adjust the position of the track to reduce slack and provide tension. Adjusting the track 10 may be required to take up track tension as the track length around the telescoping legs 20 changes as the legs retract and expand such as to navigate vertical obstacles or travelling on surfaces which are not level.

Preferably, the drive assembly 40 comprises a motor (not shown) to drive the drive wheel 41. Is anticipated that the motor can be an electric motor and may be battery-powered. In the preferred configurations, the drive assembly 40 is driven as a driveshaft or axle turns of the drive wheel 41, which in turn moves the track 10 around the track units 3.

In one configuration, the drive motor is a single shaft hub motor. In the preferred configuration, the drive assembly 40 is positioned on or near the centreline of mass of the track unit 3 as best shown in FIG. 2. A drive assembly 40 positioned at or near the centre can improve stability and balance of the track units 3. In the preferred configurations, the track units 3 have a vertical line of symmetry. Additionally, a drive assembly 40 positioned at or near the centre permits the drive wheel 41 to control both ends of the track 10. A drive assembly 40 positioned at or near the centre permits the drive wheel 41 to control equal lengths of the track.

Preferably, the drive wheel 41 has a diameter between 15 mm and 140 mm.

In the preferred configurations, the drive wheel 41 has a diameter between 20 mm and 60 mm.

In some configurations the drive wheel 41 is a sprocket-drive wheel which contacts and moves the track 10 along its surface as the drive wheel rotates. Preferably, a sprocket-drive wheel includes radial projections such as teeth or cogs to grip and impart linear motion to the track 10. A sprocket-drive wheel 41 may be advantageous as it can reduce the risk of slipping or derailment of the track 10 as the stair climbing apparatus 1 moves.

In some configurations, the surface of the track 10 which contacts the drive wheel 41 comprises protrusions, spikes or other elements to increase grip between the drive wheel and the track 10.

In some configurations the track 10 comprises apertures which correspond to spikes or protrusions of the drive wheel 41.

In the most preferred configurations, the drive assembly 40 also provides track tension. Track tension should be provided to reduce track 10 slack which may be created due to extending and retracting movable rollers 22 to allow varying track profiles. Adequate track tension should be maintained as a loose track 10 may derail off the track units 3, or the tracks may not be driven as effectively by the drive assembly 40.

In the preferred configurations, the drive assembly 40 provides the primary means of track tension. Even if other tensioning mechanisms are present, the translation of the drive assembly 40 reduces most track slack which may be present to provide track tension.

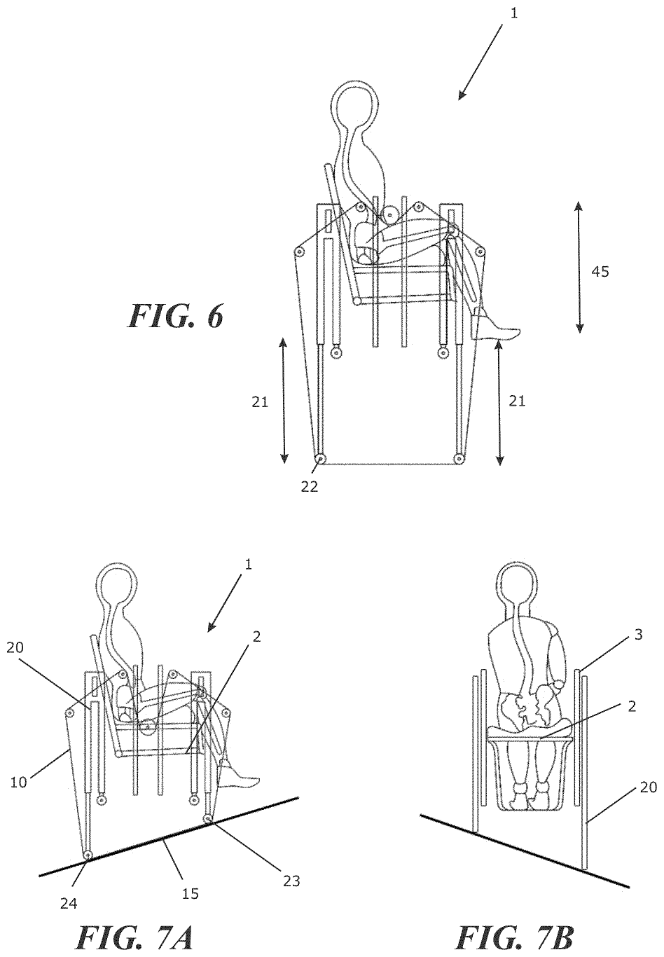

In the preferred configurations, the drive assembly 40 translates a stroke length 45 proportional to a vertical distance travelled by the movable rollers 21 as shown in FIG. 6.

In some configurations, the drive assembly 40 translates a stroke length 45 equal to half the sum of the vertical distances travelled by the movable rollers 21as illustrated in FIG. 6. For example, the drive assembly 40 translates a stroke length 45 of approximately 600 mm, where two telescoping legs 20 each extend its length by 600 mm.

Preferably, the drive assembly 40 translates a distance between 100 mm and 900 mm to move between the raised position and the lowered position to provide track tension.

In the preferred configurations, the drive assembly 40 translates a distance between 200 mm and 700 mm to move between the raised position and the lowered position to provide track tension.

Preferably, the drive assembly 40 provides the sole means of track tension.

In the preferred configurations, the drive assembly 40 can provide track tension by moving between a raised position and a lowered position to take up tension as the movable rollers 22 move between an extended condition and a retracted condition relative to the frame 4. The drive assembly 40 moves between a raised position and a lowered position by vertically translating along the track unit 3.

The raised position of the drive assembly 40 is preferably at or towards the upper region of the track unit 3. The lowered position is located at the opposite region of the raised position. Preferably, the lowered position of the drive assembly 40 is at or towards the lower region of the track unit 3.

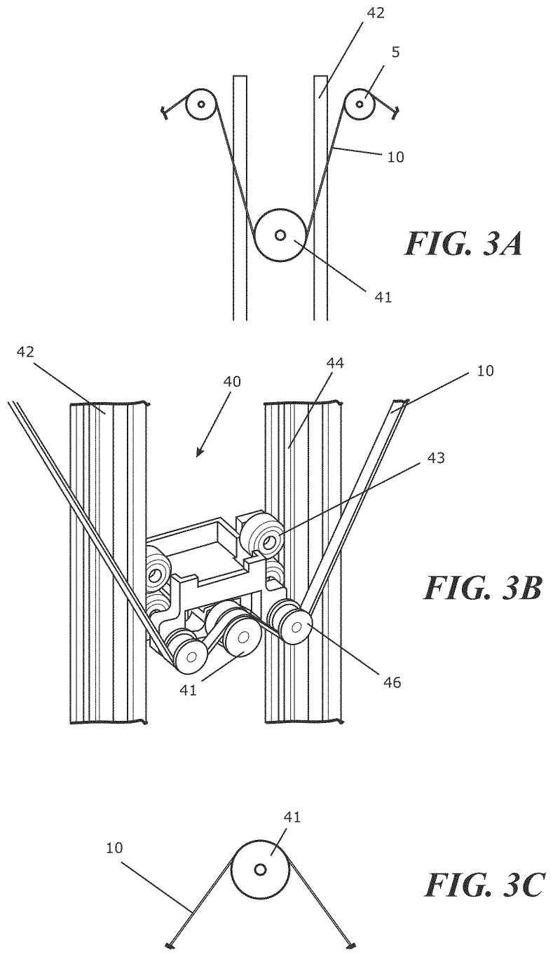

In the preferred configurations, the track units 3 comprise drive assembly guide rails 42 as best illustrated in FIGS. 2 and 3B. Preferably, the drive assembly guide rails 42 are linear rails configured to assist the drive assembly 40 with providing tension. Preferably, the drive assembly guide rails 42 guide the drive assembly 40 to travel in a linear path.

Preferably, the drive assembly guide rails 42 are two spaced apart vertically extending linear rails. Preferably, each drive assembly guide rail 42 is configured to receive a side of the drive assembly 40.

In the preferred configurations, the drive assembly guide rails 42 are parallel to the movement of the movable rollers 22.

In the preferred configuration, the drive assembly guide rails 42 are fixed onto the frame 4 of the track unit 3.

As shown in FIG. 3B, in some configurations the drive assembly 40 comprise rail guide rollers 43 configured to smoothly guide the drive assembly 40 as it translates from a raised position and lowered position to provide track tension. Preferably, the rail guide rollers 43 are configured to travel along or within a recess 44 in the drive assembly guide rails 42. In some configurations, linear bearing can be used to provide smooth translation along the rails 42.

In some configurations, the drive assembly 40 comprises a brake (not shown) to control the friction between the drive assembly 40 and the drive assembly guide rail 42. Increasing friction between the drive assembly 40 and the drive assembly guide rail 42 can assist with proving track tension to the track 10. In some configurations, less force needs to be applied to the track 10 to provide track tension if friction between the drive assembly 40 and the drive assembly guide rail 42 can resist movement of the drive assembly 40 to move away from providing tension.

In one configuration, the drive assembly 40 moves between a lowered position when the movable wheels 22 are in a retracted position (FIG. 1), to a raised position when the movable wheels 22 are in an extended position (FIG. 6).

Preferably, the drive assembly 40 moves downwards towards the lowered position to increase track tension.

Preferably, as the drive assembly 40 moves between the raised position and lowered position, the track portion surrounding the telescoping legs 16 is being adjusted to provide the required track tension. The length of the track portion surrounding the telescoping legs 16 varies as the telescoping legs 20 extend and retract. The length of the track surrounding the telescoping legs 16 when the telescoping legs 20 are extended is longer in comparison to when the legs are retracted.

In another configuration, the drive assembly 40 moves between a raised position when the movable wheels 22 are in a retracted position (FIG. 10A), to a lowered position when the movable wheels 22 are in an extended position (FIG. 10B).

Preferably, the drive assembly 40 moves upwards towards the raised position to increase track tension. Preferably, a force in the upwards direction increases track tension.

In the preferred configurations as shown in FIGS. 3A and 3B, the drive assembly 40 provides track tension by bearing its weight onto the track 10. Preferably, the track assembly 40 is configured to rest its weight on the track 10. Preferably, the drive assembly 40 provides a downward force on the track 10 to provide track tension.

In some configurations, the drive assembly 40 passively provides track tension.

In some configurations, the drive assembly 40 actively provides track tension.

In the preferred configuration, the drive assembly 40 provides track tension passively as the weight of the drive assembly 40 provides a downward force on the track 10. Preferably, the weight of the drive assembly 40 provides a downward force on the track 10 due to gravity. To counteract this downward force from the drive assembly 40, the track 10 is subject to an upward force due to the tension in the track.

Preferably, the drive assembly 40 provides a downward force on the track 10 to provide track tension. In some configurations, the motor has a significant mass in the drive assembly 40, so that as gravity acts on it, the drive assembly provides sufficient downward force on the track 10.

In some configurations, extra weights can be added to the drive assembly 40. Preferably, the drive assembly 40 comprises supplementary weight elements to provide an increased downward force on the track 10 to provide track tension.

In one configuration, as shown in FIG. 3A, the drive wheel 41 is located exterior to the track pathway of the track 10 so that it is providing a downward force on the track. Preferably, the drive wheel 41 is located external to the closed track path of the track 10.

In other configurations, as shown in FIG. 3B, the drive wheel 41 is located within the track pathway of the track 10. The drive wheel 41 is located within the closed track path of the track 10. Preferably, in this configuration, the drive assembly 40 comprises drive assembly rollers 46 configured to allow the drive assembly to rest on top of the track 10 to provide a downward force on the track 10 to provide track tension.

In yet another configuration, as shown in FIG. 3C, the drive wheel 41 is located within the track pathway of the track 10 and the drive assembly 40 is located within the closed track path of the track. As shown in FIGS. 10A and 10B, the drive assembly 40 moves upwards towards a raised position to increase track tension, and moves downwards to a lowered position to reduce track tension. Preferably, the drive wheel 41 is located within the track pathway of each respective track configured to provide an upwards force on the track.

In some configurations, each track unit 3 comprises an actuator to actively move each drive assembly 40 to a raised position or lowered position.

A drive assembly 40 capable of both driving the track 10 around the track units 3, and adjusting track tension may be advantageous as it simplifies the processes. Both the driving and tensioning mechanisms of the system acts on the track 10. It may be beneficial for both the driving and tensioning processes to be acting on one portion of the track 10. A drive assembly 40 which doubles as tensioning mechanism may reduce the wear and tear on the track as both mechanisms are acting on one portion of the track 10. In contrast, a drive wheel acting on a different portion of the track 10 to a separate tensioning wheel may not be as desirable as this may lead to a higher probability of derailment or less efficient track movement around the track units 3.

Having a drive assembly 40 which is capable of driving the track 10 and adjusting track tension provides a synergistic means of supporting the stair climbing apparatus 1 while it navigates different terrains and obstacles. A driving assembly 40 capable of providing track tension allows for a simplified and more compact apparatus 1.

Furthermore, a drive assembly 40 which also provides the tensioning means require relatively low maintenance.

A drive assembly 40 capable of providing track tension can drive the track 10 while controlling tension on both ends of the track.

In the preferred configurations, each track unit 3 comprises vertically movable rollers 22 in contact with the inner track surface 11.

In the preferred configurations, the movable rollers 22 on each track unit are located at the bottom end of vertically movable legs. Vertically movable rollers 22 on the end of legs may be advantageous as it allows the track 10 to move smoothly over the legs 20 as the track moves around the track unit 3.

Movable rollers 22 preferably guide the track 10 to prevent derailment. In some configurations, the movable rollers 22 are grouped in pairs to simulate feet as shown in FIG. 2. Preferably, the front two adjacent movable rollers are grouped together to simulate a front foot 23, and the rear two adjacent movable rollers are grouped together to simulate a rear foot 24 on each respective track unit 3.

In other configurations, a single front movable roller 22 can form a front foot 23, and/or a single rear movable roller 22 can form a rear foot 24.

Preferably, corresponding identical telescoping legs 20 on the opposite side of the stair climbing apparatus 1 form matching pairs of ‘feet”, to form a full set of four ‘feet’, one at each corner of the stair climbing apparatus as shown in FIG. 1.

In some configurations each foot 23, 24 (a pair of movable roller 22) is actuated using a single actuator to minimise costs. One telescoping leg 20 or movable roller 22 is actuated at a time.

In some configurations, such as where each foot 23, 24 is actuated by a single actuator only the outer legs are used to actively support the weight of the vehicle while travelling on inclined or uneven surfaces or to elevate the vehicle to a standing position as shown in FIGS. 6, 7A, and 7B.

In other configurations, each telescoping leg 20 or movable roller 22 is moved using an actuator.

In the preferred configurations, the actuator is a linear actuator with a relatively long stroke. In some configurations the actuator is an electro-mechanical actuators. In other configurations, the actuator is an electrically-powered hydraulic actuator. It is anticipated other actuators can be used to linearly extend and retract the movable rollers 22.

In the preferred configurations the telescoping legs 20 comprise metal for strength and durability. It is anticipated that the telescoping legs can be made from a range of different material to provide adequate strength and durability. For example, the telescoping legs 20 can be made from aluminium, alloy, strong plastic, or carbon fibre.

Preferably, the vertical distance 21 travelled by the movable rollers 22 is between 100 mm and 900 mm.

In the preferred configurations, the vertical distance 21 travelled by the movable rollers 22 is between 200 mm and 700 mm.

Preferably, the length 6 (FIG. 2) of the stair climbing apparatus 1 is between 200 mm and 900 mm.

In the preferred configurations, the length 6 of the stair climbing apparatus 1 is between 250 mm and 750 mm.

In one configuration, the length 6 of the stair climbing apparatus 1 is between 450 mm and 500 mm so the apparatus can rest on three steps as shown in FIG. 9A.

In another configuration, the length 6 of the stair climbing apparatus 1 is between 650 mm and 750 mm so the apparatus can rest on four steps as shown in FIG. 9B.

Preferably, the stair climbing apparatus 1 is able to travel along or over different surfaces and obstacles by retracting or extending the movable rollers 22. Preferably, different lower track profiles 13 are formed as the drive assembly 40 translate between a raised position and a lowered position to provide adequate tension so that the track portion 16 surrounding the movable rollers 22 is mapped to the desired profile.

Preferably, two are or more movable rollers 22 press against the inner track surface 11 to create the desired lower track profile 13.

When travelling along flat or relatively smooth surfaces, preferably the movable rollers 22 provide a smooth, linear lower track profile 13. Preferably, the movable rollers 22 contacting the track 10 are extended by the same length.

The stair climbing apparatus 1 can travel over smooth surfaces as the track 10 is driven around the track units 3 to propel the apparatus forwards efficiently. The movable rollers 22 or telescoping legs 20 do not need to move while travelling on a smooth surface, allowing efficient movement consuming low energy.

Preferably, all movable rollers 22 are fully retracted when travelling along flat or relatively smooth surfaces. When the telescoping legs 20 are fully retracted, power consumption is preferably low as extra power is not required to hold the load. Relatively low energy consumption may enable the stair climbing apparatus 1 to achieve a high moving efficiency similar to the conventional locomotion mechanisms (such as wheels and tracks).

Preferably, the movable rollers 22 or telescoping legs 20 can extend or retract to achieve varying heights for the different purposes.

Preferably, the stair climbing apparatus 1 comprises a standing mode as shown in FIG. 6. Preferably, in this mode the movable rollers 22 contacting the track 10 are fully extended. A standing mode may enable a person sitting on the apparatus 1 to effectively rise to human standing height, allowing them to reach items on high shelves or to have eye-level discussions with other people.

In the preferred configurations, the outer two movable rollers 22 extend to achieve the desired height as shown in FIG. 6. Extending the outer legs 20 may achieve the desired height, while providing a stable apparatus. Additionally, extending the outer legs 20 can minimise energy consumption as not all legs are extended.

In other configurations, two or more movable rollers 22 extend to achieve the desired height. This may be desirable where optimal stability is desired.

Preferably, the movable rollers 22 can be extended to provide active suspension to the stair climbing apparatus 1. Preferably, the movable rollers 22 are extended by the required length to keep the support platform 2 horizontal even on an inclined surface as shown in FIGS. 7A and 7B.

Preferably, the stair climbing apparatus 1 can withstand an inclined surface which inclines along a longitudinal axis as shown in FIG. 7A. Preferably, the front movable roller 23 is extended a different amount to the rear movable roller 24.

Preferably, the stair climbing apparatus 1 can withstand an inclined surface which inclines along a lateral axis as shown in FIG. 7B. Preferably, the movable rollers 22 on one track unit 3 is extended a different amount to the movable rollers 22 on the opposite track unit 3.

Preferably, the stair climbing apparatus 1 can lift its front foot 23 by retracting its front foot and/or extending its rear foot 24 to step onto a higher surface as shown in FIG. 9A. Preferably, the stair climbing apparatus 1 can navigate vertical obstacles such as curbs, stairs, uneven terrain, or to a secondary mode of transportation such as a van.

When negotiating stairs, preferably, the apparatus 1 is able to perform a stable motion by extending and retracting the movable rollers 22 up and down, to adjust to the shape of the stairs. FIGS. 8A to 8D illustrates a sequence of actions to climb up stairs. If reversed, FIGS. 8D to 8A illustrates a sequence of climbing down stairs. It is anticipated that it is possible for the apparatus 1 to change its direction (moving upwards or downwards) when climbing up and down the stairs.

Preferably, at any point during the stair climbing motion, at each corner of the stair climbing apparatus 1, there is at least one active movable roller 22 or leg 20, which stays firmly on a step to support the apparatus 1. The stair climbing apparatus 1 may therefore remain stable even when climbing stairs or moving across obstacles.

As the stair climbing apparatus 1 negotiates a step or other vertical obstacle, the movable rollers 22 extend and retract as required, the drive assembly 40 moves upwards and downwards to provide track tension 10.

The present stair climbing apparatus 1 comprising a track 10 and movable rollers 22 can be advantageous as the apparatus is supported on the horizontal surface of the vertical obstacle and not the edges. This increases the stability of the apparatus 1 and reduces the risk of sliding down stairs or falling off other vertical obstacles.

In some configurations the stair climbing apparatus 1 comprises one or more sensors to gather environmental information and/or to observe the state of the hardware. For example, sensors may be able to determine the geometry of approaching obstacles.

In some configurations, the apparatus further comprises low-level sensors. Preferably, the apparatus 1 comprises contact, proximity and/or distance sensors. In some configurations, the apparatus comprises a tactile and limit switch so that if the movable rollers 22 are pushed in by an object, such as a step, the movable rollers will retract in length to the corresponding obstacle shape.

In some configurations, the apparatus further comprises advanced sensors such as such as computer vision and 3D sensors such as laser scanners or light detection to enable the apparatus 1 to operate autonomously or partially autonomously. In some configurations, a microcontroller automatically adjusts the elevation of the apparatus 1 by adjusting the length of the telescoping legs 20 or vertical translation of the movable rollers 22. Preferably, the operator will only need to control the speed and direction of apparatus 1, while the microcontroller automatically adjusts the elevation.

Preferably, the apparatus 1 comprises sensors to observe the performance of the apparatus 1. For example a load-sensing sensor such as installed between the leg and the movable rollers 22. The load-sensing element can be a load cell, strain gauge, pressure sensor or similar, as is known in the art.

In some configurations the movable legs 20 are equipped with a potentiometer that enables determination of the current position of each leg.

In some configurations an accelerometer and gyro sensors can observe tilt and acceleration.

In some configurations, the apparatus 1 includes a track tension monitoring system.

In some configurations, the apparatus 1 includes a clutch (not shown). When the stair climbing apparatus 1 is stationary, it may be useful to allow the track 10 to move freely. Preferably, a clutch is coupled between the drive motor and the drive wheel 41. When necessary, the clutch allows rotation of the track 10 without rotation of the motor in the drive assembly 40.

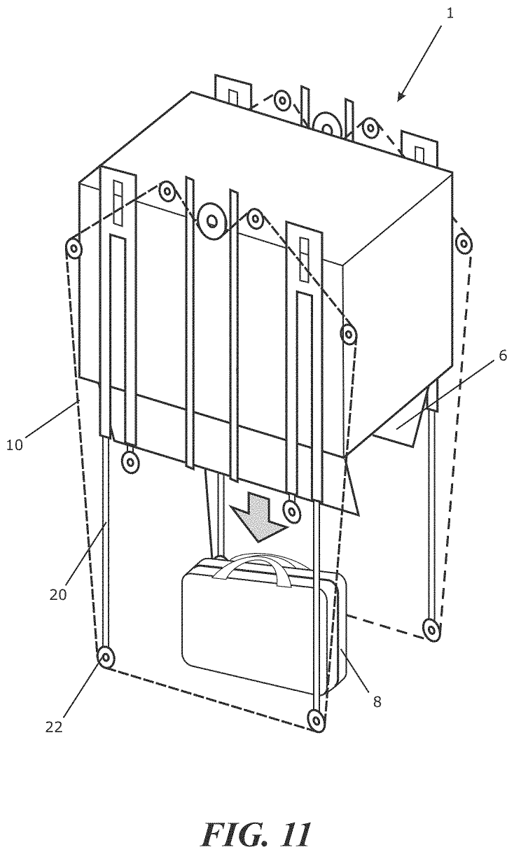

As shown in FIG. 11, in some configurations, the stair climbing apparatus 1 is able to deliver articles and autonomously unload the articles 8 without human intervention. Preferably, the stair climbing apparatus 1 comprises a lower door 6 which unloads an article below the apparatus. Preferably, the lower door 6 is controlled by an actuator.

In some configurations, as shown in FIG. 11, the lower door 6 comprises two flaps which open downwards to release the article. In other configurations, the lower door 6 is a single door flap or a sliding door.

In some configurations, the apparatus 1 comprises an actuator to load the parcel through the lower door 6 autonomously.

In some configurations, the lower door 6 acts as a support platform 2 when it is in the closed position. In other configurations, the lower door 6 is separate from the support platform 2.

A stair climbing apparatus 1 comprising a lower door 6 to unload articles 8 provides a synergistic advantage as an article can be delivered and safely unloaded. Preferably, the article is unloaded when the telescoping legs 20 are in a retracted or partially retracted condition. This minimises or eliminates the distance between the lower door 6 and the ground surface to reduce the likelihood of damage to the article 8 when it is unloaded. When the article 8 has been unloaded, the telescoping legs 20 may extend to lift the apparatus 1 upwards and away from the article so that the article is not in the way of apparatus moving away.

Unloading an article 8 in this manner may be advantageous as the article 8 can be delivered safely as the distance between the lower doors 6 and the ground surface can be adjusted. Furthermore, this mechanism requires low energy consumption, as a supplementary article removing mechanism such as a claw is not necessary.

In some configurations, an actuator system can also load the parcel through the lower doors 6 autonomously.

To those skilled in the art to which the invention relates, many changes in construction and widely differing embodiments and applications of the invention will suggest themselves without departing from the scope of the invention as defined in the appended claims.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

1. A stair climbing apparatus comprising:
a frame,
a pair of track units positioned on opposite sides of the frame, each track unit comprising:
a track having an inner track surface and an outer track surface,
a plurality of rollers in contact with the inner track surface configured to guide the track around a track pathway, and
a drive assembly comprising a drive wheel in contact with the track, and
wherein the drive assemblies are movable between a raised position and a lowered position and provides track tension.

2. A stair climbing apparatus as claimed in claim 1, wherein each drive assembly provides the primary means of track tension for each respective track.

3. A stair climbing apparatus as claimed in claim 1, wherein each drive assembly provides the sole means of track tension for each respective track.

4. A stair climbing apparatus as claimed in claim 1, wherein four of more of the rollers on each track unit are movable rollers vertically moveable relative to the frame.

5. A stair climbing apparatus as claimed in claim 1 wherein two or more of the rollers on each track unit are fixed carrier rollers mounted in fixed positions on the frame.

6. A stair climbing apparatus as claimed in claim 1, wherein each drive assembly translates a stroke length proportional to a vertical distance travelled by the movable rollers.

7. A stair climbing apparatus as claimed in claim 6, wherein each drive assembly translates a stroke length equal to half the sum of the vertical distances travelled by the movable rollers.

8. A stair climbing apparatus as claimed in claim 1, wherein each drive assembly is positioned on or near the centreline of mass of each respective the track unit.

9. A stair climbing apparatus as claimed in claim 1, wherein each drive assembly is movable between the raised position and the lowered position to take up tension as the movable rollers move between an extended condition and a retracted condition relative to the frame.

10. A stair climbing apparatus as claimed in claim 4, wherein the movable rollers on each track unit are located at the bottom end of vertically movable telescoping legs.

11. A stair climbing apparatus as claimed in claim 1, wherein each track pathway is in an inclined plane with respect to a vertical plane.

12. A stair climbing apparatus as claimed in claim 1, wherein the two drive assemblies can move independently from each other.

13. A stair climbing apparatus as claimed in claim 1, wherein each drive assembly provides a downward force on the track to provide track tension.

14. A stair climbing apparatus as claimed in claim 1, wherein each drive assembly provides track tension passively as the weight of the drive assembly provides a downward force on the track.

15. A stair climbing apparatus as claimed in claim 1, wherein each drive assembly comprises supplementary weight elements to provide an increased downward force on the track.

16. A stair climbing apparatus as claimed in claim 1, wherein each drive wheel is located exterior to the track pathway of each respective track and provides a downward force on the track.

17. A stair climbing apparatus as claimed in claim 1, wherein each track unit comprises an actuator to actively move each drive assembly to a raised position or lowered position.

18. A stair climbing apparatus as claimed in claim 1, wherein each track forms an enclosed track pathway.

19. A stair climbing apparatus as claimed in claim 1, wherein the front two adjacent movable rollers are grouped together to simulate a front foot, and the rear two adjacent movable rollers are grouped together to simulate a rear foot on each respective track unit.

20. A stair climbing apparatus as claimed in claim 1, wherein the apparatus comprises a lower door to unload an article below the apparatus.

21. A stair climbing apparatus as claimed in claim 1, wherein the track is a continuous flexible track.
